(19) United States
(12) Patent Application Publication
(10) Pub. No.: US 2017/0213294 A1
(43) Pub. Date: Jul. 27, 2017

(54) METHODS, SYSTEMS AND COMPUTER PROGRAM PRODUCTS FOR CALCULATING AN ESTIMATED RESULT OF A TAX RETURN

(71) Applicant: INTUIT INC., Mountain View, CA (US)

(72) Inventors: Luis Felipe Cabrera, Bellevue, WA (US); Henry Tayloe Stansbury, Saratoga, CA (US); William T. Laaser, Palo Alto, CA (US)

(21) Appl. No.: 15/008,025

(22) Filed: Jan. 27, 2016

(51) Int. Cl. G06Q 40/00

(52) U.S. Cl. CPC G06Q 40/123

(57) ABSTRACT

A system for calculating an estimated result during preparation of an electronic tax return includes a server computer having a predictive model, and a tax return preparation computer having an electronic tax return preparation program. The server computer is configured to obtain a first taxpayer datum and execute the predictive model, which analyzes the first taxpayer datum to identify a most relevant taxpayer data category. The server computer is configured to communicate the taxpayer data category to the tax return preparation computer. The tax return preparation computer is configured to obtain a second taxpayer datum corresponding to the taxpayer data category, calculate the estimated result for the taxpayer based on the second taxpayer datum, and display the estimated result to a user during preparation of the electronic tax return.

This application includes subject matter similar to the subject matter described in the following co-owned applications: (1) attorney docket no. INT-243-US1 (158523), entitled “Methods System and Articles of Manufacture for Using a Predictive Model to Determine Tax Topics Which are Relevant to a Taxpayer in Preparing an Electronic Tax Return”; (2) attorney docket no. INT-244-US1 (158521), entitled “Identification of Electronic Tax Return Errors Based on Declarative Constraints”; (3) attorney docket no. INT-245-US1 (158524), entitled “Predictive Model Based Identification of Potential Errors in Electronic Tax Return”; (4) attorney docket no. INT-263-US1 (158622), entitled “Methods, Systems and Computer Program Products for Calculating an Estimated Result of a Tax Return”; (5) attorney docket no. INTU158631, entitled “Methods and Systems for Identifying Product Defects Within a Tax Return Preparation System”; (6) attorney docket no. INT-264-US1 (158633), entitled “Systems for Identifying Abandonment Indicators for an Electronic Tax Return Preparation Program”; (7) attorney docket no. INT-265-US1 (158636), entitled “Systems for Allocating Resources Based on Electronic Tax Return Preparation Program User Characteristics”; and (8) attorney docket no. INT-285-US1 (169315), entitled “Methods, Systems and Computer Program Products for Calculating an Estimated Result of a Tax Return.” The contents of applications attorney docket nos. INT-243-US1 (158523), INT-244-US1 (158521), INT-245-US1 (158524), INT-263-US1 (158622), INTU158631, INT-264-US1 (158633), INT-265-US1 (158636), and INT-285-US1 (169315) are fully incorporated herein by reference as though set forth in full.

### SUMMARY

Embodiments are directed to systems, computer-implemented methods, and computer program products for calculating an estimated result while preparing an electronic tax return.

In one embodiment directed to a system for calculating an estimated result during preparation of an electronic tax return, the system includes a server computer having a predictive model running thereon. The system also includes a tax return preparation computer operatively coupled to the server computer by a network and having an electronic tax return preparation program running thereon. The server computer is configured to obtain a first taxpayer datum associated with a taxpayer and execute the predictive model. The predictive model, when executed, analyzes the first taxpayer datum to identify a taxpayer data category as most relevant to the estimated result for the taxpayer. The server computer is configured to communicate the taxpayer data category identified as most relevant to the tax return preparation computer. The tax return preparation computer is configured to obtain a second taxpayer datum associated with the taxpayer and corresponding to the taxpayer data category identified as most relevant. The tax return preparation computer is configured to calculate the estimated result for the taxpayer based, at least in part, on the second taxpayer datum. The tax return preparation computer is configured to display the estimated result to a user during preparation of the electronic tax return.

In a single or multiple embodiments, the predictive model is an algorithm that was created using a modeling technique selected from the group consisting of Pearson product-moment correction; sensitivity analysis; logistic regression; naive bayes; k-means classification; K-means clustering; other clustering techniques; k-nearest neighbor; neural networks; decision trees; random forests; boosted trees; k-nn classification; kd trees; generalized linear models; support vector machines; and substantial equivalents thereof.

In a single or multiple embodiments, the server computer is configured to obtain the first taxpayer datum from the tax return preparation computer. The tax return preparation computer may be configured to obtain the first taxpayer datum from the user or from a taxpayer data computer. The server computer may be configured to obtain the first taxpayer datum from a taxpayer data computer. The tax return preparation computer may be configured to obtain the second taxpayer datum from the user or from a taxpayer data computer. The taxpayer data computer may be a third party computer.

In a single or multiple embodiments, communicating the taxpayer data category identified as the most relevant to the estimated result for the taxpayer includes communicating a sequence of taxpayer data categories with the taxpayer data category at a beginning of the sequence.

In a single or multiple embodiments, the predictive model includes data analytics. Executing the predictive model may include calculating a Pearson product-moment correlation coefficient. Executing the predictive model may include calculating a change in the estimated result based on a change to the taxpayer data category.

Executing the predictive model may include determining a correlation between the taxpayer data category and the estimated result in a plurality of tax returns. Executing the predictive model may include analyzing a tax code.

In a single or multiple embodiments, executing the predictive model includes determining a first correlation between the taxpayer data category and a second taxpayer data category; determining a second correlation between the estimated result and the second taxpayer data category; and determining a third correlation between the taxpayer data category and the estimated result based on the first and second correlations. Executing the predictive model may also include calculating a first correlation coefficient between the taxpayer data category and the second taxpayer data category; calculating a second correlation coefficient between the estimated result and the second taxpayer data category; and calculating a third correlation coefficient between the taxpayer data category and the estimated result based on the first and second correlation coefficients.

In a single or multiple embodiments, executing the predictive model includes calculating a plurality of correlation coefficients for a respective first plurality of taxpayer data categories and the estimated result; eliminating one of the first plurality of taxpayer data categories having a lowest correlation coefficient of the plurality of correlation coefficients from the first plurality of taxpayer data categories to form a second plurality of taxpayer data categories; repeating the first two steps with respective pluralities of taxpayer data categories until a single last taxpayer data category remains; and identifying the single last taxpayer data category as the most relevant to the estimated result for the taxpayer.

In a single or multiple embodiments, executing the predictive model includes requesting the user to identify the taxpayer data category as the most relevant to the estimated result for the taxpayer.

In another embodiment directed to a computer-implemented method for calculating an estimated result during preparation of an electronic tax return, the method includes obtaining a first taxpayer datum associated with a taxpayer. The method also includes executing a predictive model. The method further includes analyzing the first taxpayer datum to identify a taxpayer data category as most relevant to the estimated result for the taxpayer. The method further includes obtaining a second taxpayer datum associated with the taxpayer and corresponding to the taxpayer data category identified as most relevant. Moreover, the method includes calculating the estimated result for the taxpayer based, at least in part, on the second taxpayer datum. In addition, the method includes displaying the estimated result to a user during preparation of the electronic tax return.

In a single or multiple embodiments, the predictive model is an algorithm that was created using a modeling technique selected from the group consisting of Pearson product-moment correction; sensitivity analysis; logistic regression; naive bayes; k-means classification; K-means clustering; other clustering techniques; k-nearest neighbor; neural networks; decision trees; random forests; boosted trees; k-nn classification; kd trees; generalized linear models; support vector machines; and substantial equivalents thereof.

In a single or multiple embodiments, the first taxpayer datum is obtained from the user or from a taxpayer data computer. The second taxpayer datum may be obtained from the user or from a taxpayer data computer. The taxpayer data computer may be a third party computer.

In a single or multiple embodiments, the method also generating a sequence of taxpayer data categories with the taxpayer data category at a beginning of the sequence.

In a single or multiple embodiments, the predictive model includes data analytics. Executing the predictive model may include calculating a Pearson product-moment correlation coefficient. Executing the predictive model may include calculating a change in the estimated result based on a change to the taxpayer data category. Executing the predictive model may include determining a correlation between the taxpayer data category and the estimated result in a plurality of tax returns. Executing the predictive model may include analyzing a tax code.

In a single or multiple embodiments, executing the predictive model includes determining a first correlation between the taxpayer data category and a second taxpayer data category; determining a second correlation between the estimated result and the second taxpayer data category; and determining a third correlation between the taxpayer data category and the estimated result based on the first and second correlations. Executing the predictive model may also include calculating a first correlation coefficient between the taxpayer data category and the second taxpayer data category; calculating a second correlation coefficient between the estimated result and the second taxpayer data category; and calculating a third correlation coefficient between the taxpayer data category and the estimated result based on the first and second correlation coefficients.

In a single or multiple embodiments, executing the predictive model includes calculating a plurality of correlation coefficients for a respective first plurality of taxpayer data categories and the estimated result; eliminating one of the first plurality of taxpayer data categories having a lowest correlation coefficient of the plurality of correlation coefficients from the first plurality of taxpayer data categories to form a second plurality of taxpayer data categories; repeating the first two steps with respective pluralities of taxpayer data categories until a single last taxpayer data category remains; and identifying the single last taxpayer data category as the most relevant to the estimated result for the taxpayer.

In a single or multiple embodiments, executing the predictive model includes requesting the user to identify the taxpayer data category as the most relevant to the estimated result for the taxpayer.

In still another embodiment directed to a computer program product including a non-transitory computer readable storage medium embodying one or more instructions executable by a computer system having a server computer and a tax return preparation computer to perform a process for calculating an estimated result during preparation of an electronic tax return. The process includes obtaining a first taxpayer datum associated with a taxpayer. The process also includes executing a predictive model. The process further includes analyzing the first taxpayer datum to identify a taxpayer data category as most relevant to the estimated result for the taxpayer. The process further includes obtaining a second taxpayer datum associated with the taxpayer and corresponding to the taxpayer data category identified as most relevant. Moreover, the process includes calculating the estimated result for the taxpayer based, at least in part, on the second taxpayer datum. In addition, the process includes displaying the estimated result to a user during preparation of the electronic tax return.

### BRIEF DESCRIPTION OF THE DRAWINGS

The foregoing and other aspects of embodiments are described in further detail with reference to the accompanying drawings, in which the same elements in different figures are referred to by common reference numerals, wherein:

FIGS. 1 to 3 are schematic diagrams illustrating the implementation of estimated result calculation systems on computing devices according to various embodiments.

FIGS. 4 to 7 are block diagrams of computer systems according to various embodiments on which estimated result calculation systems according to various embodiments may be implemented.

FIG. 8 is a block diagram of a computing apparatus or system in which various embodiments may be implemented or that may be utilized to execute various embodiments.

FIGS. 9 to 16 are flow charts depicting computer-implemented methods of calculating estimated results during preparation of an electronic tax return according to various embodiments.

In order to better appreciate how to obtain the above-recited and other advantages and objects of various embodiments, a more detailed description of embodiments is provided with reference to the accompanying drawings. It should be noted that the drawings are not drawn to scale and that elements of similar structures or functions are represented by like reference numerals throughout. It will be understood that these drawings depict only certain illustrated embodiments and are not therefore to be considered limiting of scope of embodiments.

### DETAILED DESCRIPTION OF ILLUSTRATED EMBODIMENTS

Embodiments describe methods, systems and articles of manufacture for calculating an estimated result while preparing an electronic tax return. In particular, the embodiments describe predicting which taxpayer data are more relevant to a particular taxpayer's estimated result, and prioritizing acquisition of that more relevant taxpayer data to provide a more accurate estimated result earlier in the electronic tax return preparation process.

Some current electronic tax return preparation systems are configured to calculate an estimated result, which is displayed to a user during entry of taxpayer data as an aid to the user. Current systems calculate the estimated result based on entered taxpayer data, with all other taxpayer data set to empty, zero or not applicable. Other systems predict yet to be entered taxpayer data to generate a more accurate estimated result as described in U.S. patent application attorney docket no. INT-263-US1 (158622), the contents of which have been previously incorporated-by-reference herein. However, even with prediction of yet to be entered taxpayer data, current systems obtain taxpayer data in a predetermined order without regard to the relevance of the taxpayer data to a particular taxpayer's estimated result.

Some current systems update the estimated result after entry of each item of taxpayer data, or after each page of a taxpayer data entry user interface. Accordingly, the estimated result can change drastically after entry of taxpayer data with large effects on (i.e., more relevant to) the estimated result (e.g., interest or dividend income, child tax credit, mortgage deductions, etc.). Due to the predetermined order for obtaining taxpayer data and variability of the financial situations of taxpayers, these drastic changes in the estimated result can occur at random and unexpected times during the electronic tax return preparation process. Drastic changes (i.e., severe noise) in the estimated result displayed to the user and occurring at random and unexpected times can have unwanted results. For instance, a user may become discouraged and abandon the electronic application, or a user may unfairly lose confidence in the electronic tax return preparation system when a displayed “expected refund” disappears or becomes an “amount owed.” Obtaining taxpayer data (e.g., by presenting questions) in a predetermined order exacerbates this problem due to the variable effect of particular taxpayer data on the expected result of particular taxpayers.

The embodiments described herein more accurately obtain an estimated result earlier in the electronic tax return preparation process by using a predictive model to identify taxpayer data that should be more relevant to a particular taxpayer's estimated result. The taxpayer data identified as more relevant (and not yet obtained) is obtained earlier in the electronic tax return preparation process (e.g., by changing the order of interview questions), and used to generate a more accurate estimated result earlier in the electronic tax return preparation process. Obtaining more relevant taxpayer data earlier in the electronic tax return preparation process provides an earlier and more accurate estimated result because the taxpayer data that is more likely to affect the estimated result is obtained (either from the user or from another reliable source) earlier. Therefore, the estimated result can be generated using more relevant taxpayer data (with or without other estimated taxpayer data). This also minimizes drastic changes in the expected results because more relevant taxpayer data is obtained earlier in the process. The relevance of taxpayer data can be reevaluated as the user enters more taxpayer data (including previously identified relevant taxpayer data), to increase the accuracy of the relevance determination and, therefore, the estimated result. More accurately calculating an estimated result reduces drastic changes in the estimated result during electronic tax return preparation, and user frustration associated with such drastic changes.

Obtaining the more relevant taxpayer data can also include messaging informing the user that the more relevant taxpayer data will result in a more accurate estimate of the results. Such messaging can prepare users for large changes in the estimated result, thereby increasing and maintaining the user's engagement in the electronic tax return preparation process and confidence in the electronic tax return preparation system. The estimated result is also preferably calculated in a “shadow” electronic tax return, which cannot be completed and mistakenly filed with a tax authority.

In the described embodiments, many methods can be used to identify more relevant taxpayer data. For instance, a new user with no historical taxpayer data available to the electronic tax return preparation system may begin by providing the system with personal information and W-2 information. Based on the user provided taxpayer information and analysis of other tax filers having similar characteristics using various models, the system determines that mortgage interest deduction is likely to have a large impact on the user's estimated result. The system informs the user that it can provide a more accurate estimated result if the user provides mortgage interest paid next. The personalized process and messaging may increase the user's confidence in and engagement with the system and prepare the user for large changes in the estimated result. Optionally, a predetermined amount of more relevant taxpayer data may be collected before displaying any estimated result. The user provides the mortgage interest deduction, and the system generates a more accurate estimated result based, in part, on the mortgage interest deduction. The user sees the estimated result is within the range of the user's expected result, which further increases confidence and engagement.

In the next cycle, the system reevaluates the relevance of the taxpayer data in view of the recently provided mortgage interest paid, and determines that property tax and interest income are now likely to have the largest impacts on the estimated result. The user then provides that information, and sees a small change in the estimated result. The relatively small change in the estimated result also increases confidence and engagement. This system avoids unwarranted expectations that may reflect poorly on the system.

The embodiments described herein address the computer-specific problem of calculating and displaying a more accurate estimated result earlier in the computer tax return preparation process. Some embodiments address this issue by leveraging data available through the Internet to identify taxpayer data categories more relevant to a particular taxpayer. The embodiments obtain this more relevant taxpayer data earlier in the computer tax return preparation process, and use the more relevant taxpayer data to calculate a more accurate estimated result earlier in the computer tax return preparation process for display to a user.

As used in this application, a “preparer,” “user” or “taxpayer” includes, but is not limited to, a person preparing a tax return using tax return preparation software. The “preparer,” “user” or “taxpayer” may or may not be obligated to file the tax return. As used in this application, a “previous tax return” or “prior tax return” includes, but is not limited to, a tax return (in electronic or hard copy form) for a year before the current tax year. As used in this application, “tax data” includes, but is not limited to, information that may affect a user's income tax burden, including information typically included in a tax return. As used in this application, “taxpayer data” includes, but is not limited to, information relating to a taxpayer, including, but not limited to, tax data. The terms “tax data” and “taxpayer data,” as used in this application, also include, but are not limited to, partially or fully completed tax forms (electronic and hard copy) that include information typically included in a tax return.

As used in this application, “taxpayer data category” includes, but is not limited to, a generic class of tax data (e.g., mortgage interest paid or property tax paid). As used in this application, “estimated result” includes, but is not limited to, a tax return preparation result calculated from less than all of the required tax data (e.g., total taxes due-line 63 on Form 1040, refund-line 75 on Form 1040, or amount owed-line 78 on Form 1040). As used in this application, “a taxpayer data category being most relevant to an estimated result” includes, but is not limited to having the largest effect on the estimated result, per percentage change in value of the taxpayer data category.

As used in this application, “financial management system” includes, but is not limited to, software that oversees and governs an entity's income, expenses, and assets. An exemplary financial management system is MINT Financial Management Software, which is available from Intuit Inc. of Mountain View, Calif. A financial management system is executed to assist a user with managing its finances, and is used solely for financial management. Financial management systems manage financial transaction data from financial transaction generators such as accounts including checking, savings, money market, credit card, stock, loan, mortgage, payroll or other types of account. Such financial transaction generators can be hosted at a financial institution such as a bank, a credit union, a loan services or a brokerage. Financial transaction data may include, for example, account balances, transactions (e.g., deposits, withdraws, and bill payments), debits, credit card transactions (e.g., for merchant purchases). Financial management systems can also obtain financial transaction data directly from a merchant computer or a point of sale terminal. Financial management systems can include financial transaction data aggregators that manage and organize financial transaction data from disparate sources. While certain embodiments are described with reference to MINT Financial Management Software, the embodiments described herein can include other financial management systems such as QUICKEN Financial Management Software, QUICKRECIPTS Financial Management Software, FINANCEWORKS Financial Management Software, Microsoft Money Financial Management Software and YODLEE Financial Management Software (available from Yodlee, Inc. of Redwood City, Calif.).

As used in this application, “tax code” includes, but is not limited to, taxation-related statutes and regulations for various jurisdictions (e.g., state and federal), including the United States of America and other jurisdictions around the world.

As used in this application, “computer,” “computer device,” or “computing device” includes, but are not limited to, a computer (laptop or desktop) and a computer or computing device of a mobile communication device, smartphone and tablet computing device such as an IPAD (available from Apple Inc. of Cupertino, Calif.). As used in this application, “tax preparation system,” “tax preparation computing device,” “tax preparation computer,” “tax preparation software,” “tax preparation module,” “tax preparation application,” “tax preparation program,” “tax return preparation system,” “tax return preparation computing device,” “tax return preparation computer,” “tax return preparation software,” “tax return preparation module,” “tax return preparation application,” or “tax return preparation program” includes, but are not limited to, one or more separate and independent software and/or hardware components of a computer that must be added to a general purpose computer before the computer can prepare tax returns, and computers having such components added thereto.

As used in this application, “server” or “server computer” includes, but is not limited to, one or more separate and independent software and/or hardware components of a computer that must be added to a general purpose computer before the computer can receive and respond to requests from other computers and software in order to share data or hardware and software resources among the other computers and software, and computers having such components added thereto. As used in this application, “predictive model” includes, but is not limited to, one or more separate and independent components of a computer that must be added to a general purpose computer before the computer can identify a taxpayer data category as most relevant to an estimated result for a particular taxpayer.

As used in this application, “input/output module” includes, but is not limited to, one or more separate and independent software and/or hardware components of a computer that must be added to a general purpose computer before the computer can communicate with and facilitate the receipt and transfer of information, including taxpayer data and taxpayer data categories, from and to other computers. As used in this application, “memory module” includes, but is not limited to, one or more separate and independent software and/or hardware components of a computer that must be added to a general purpose computer before the computer can store information, including taxpayer data and taxpayer data categories. As used in this application, “correlation/relevance module” includes, but is not limited to, one or more separate and independent software and/or hardware components of a computer that must be added to a general purpose computer before the computer can determine the correlation and/or relevance of a taxpayer data category to an estimated result. As used in this application, “data sequence module” includes, but is not limited to, one or more separate and independent software and/or hardware components of a computer that must be added to a general purpose computer before the computer can generate a sequence in which to obtain taxpayer data.

As used in this application, “website” includes, but is not limited to, one or more operatively coupled webpages. As used in this application, “browser” or “web browser” includes, but is not limited to, one or more separate and independent software and/or hardware components of a computer that must be added to a general purpose computer before the computer can receive, display and transmit resources from/to the World Wide Web.

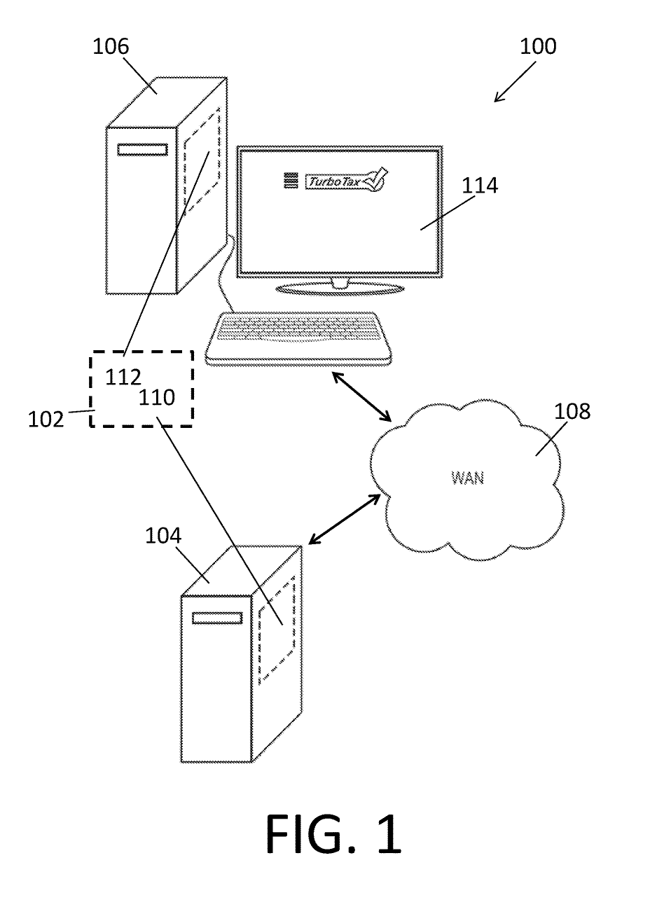

FIG. 1 depicts an exemplary hardware system 100 on which an estimated result calculation system 102 according to one embodiment can be executed. The hardware system 100 according to this embodiment includes a server computing device 104 and a tax return preparation computing device 106, which are operatively coupled via a network 108. The network 108 may be two or more networks depending on the system configuration and communication protocols employed. One or more or all of networks 108 may be, for example, a wireless or cellular network, a Local Area Network (LAN) and/or a Wide Area Network (WAN). Reference to network 108 generally is not intended to refer to a specific network or communications protocol, and embodiments can be implemented using various networks 108 and combinations thereof.

The estimated result calculation system 102 includes a predictive model 110 running on the server computing device 104 and a tax return preparation program 112 running on the tax return preparation computing device 106. The various computing devices 104, 106 may include visual displays or screens 114 operatively coupled thereto. In the embodiment depicted in FIG. 1, the tax return preparation computing device 106 includes a display or a screen 114 through which a user physically interfaces with the tax return preparation computing device 106 and the tax return preparation program 112 running thereon.

While the tax return preparation computing device 106 in FIG. 1 is depicted as a desktop computer running a tax return preparation computing program 112 thereon, in other embodiments, a tax return preparation computing program 112 may run on another computing device (e.g., the server computing device 104). In some embodiments, the tax return preparation computing program 112 (running on another computing device) may be accessed by a browser running on the tax return preparation computing device 106. In other embodiments, the tax return preparation computing program 112 (running on another computing device) may be accessed by an application running on the tax return preparation computing device 106, which would be a mobile computing device. In such embodiments, communication may occur over a private communication network (e.g., mobile phone network).

Examples of tax return preparation programs 112 that may be programmed to incorporate or utilize predictive model 110 according to embodiments include desktop or online versions of TURBOTAX, PROSERIES, and LACERTE tax return preparation applications, available from Intuit Inc. TURBOTAX, PROSERIES AND LACERTE are registered trademarks of Intuit Inc., Mountain View Calif.

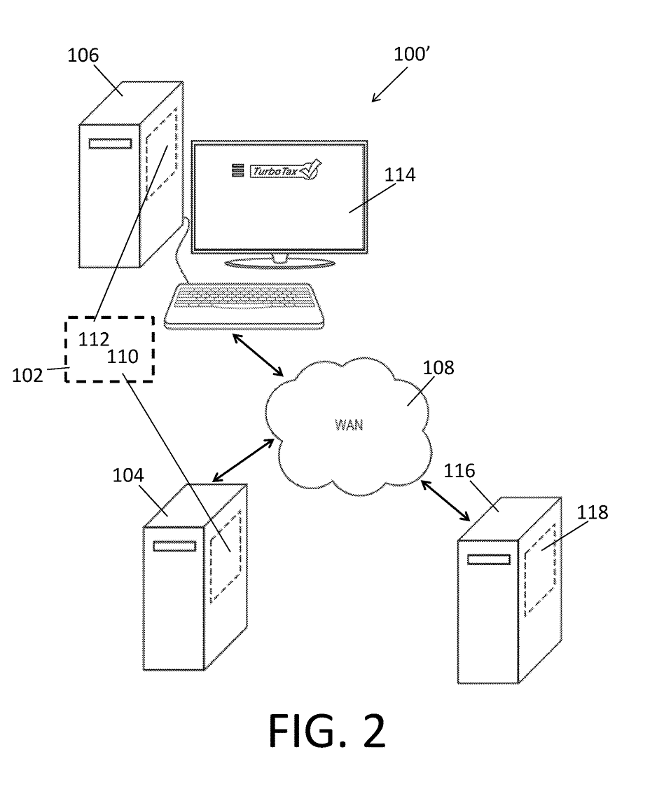

FIG. 2 depicts another exemplary hardware system 100′ on which an estimated result calculation system 102 according to another embodiment can be executed. The hardware system 100′ depicted in FIG. 2 is similar to the hardware system 100 depicted in FIG. 1. However, in addition to the server computing device 104 and the tax return preparation computing device 106, the hardware system 100′ also includes a taxpayer data computing device 116 operatively coupled to the server computing device 104 and the tax return preparation computing device 106 via the network 108. The taxpayer data computing device 116 hosts a taxpayer data program 118, from which the server computing device 104 and the tax return preparation computing device 106 may obtain taxpayer data.

Exemplary taxpayer data programs 118 include financial management systems utilized by the taxpayer (such as MINT or QUICKEN financial management systems), accounts the taxpayer has with an online social media website, third parties databases or resources (such as government databases or documents, such as property tax records, Department of Motor Vehicle (DMV) records), and other external sources of taxpayer data. MINT and QUICKEN are registered trademarks of Intuit Inc., Mountain View, Calif. While FIG. 2 depicts the server computing device 104, the tax return preparation computing device 106 and the taxpayer data computing device 116 as being operatively coupled by the same network 108, in other embodiments, these computing devices may be operatively coupled by two or three networks. While FIG. 2 depicts the predictive model 110 and the taxpayer data program 118 as running on separate computing devices 104, 116, in other embodiments, the predictive model 110 and the taxpayer data program 118 may run on the same computing device (e.g., the server computing device 104).

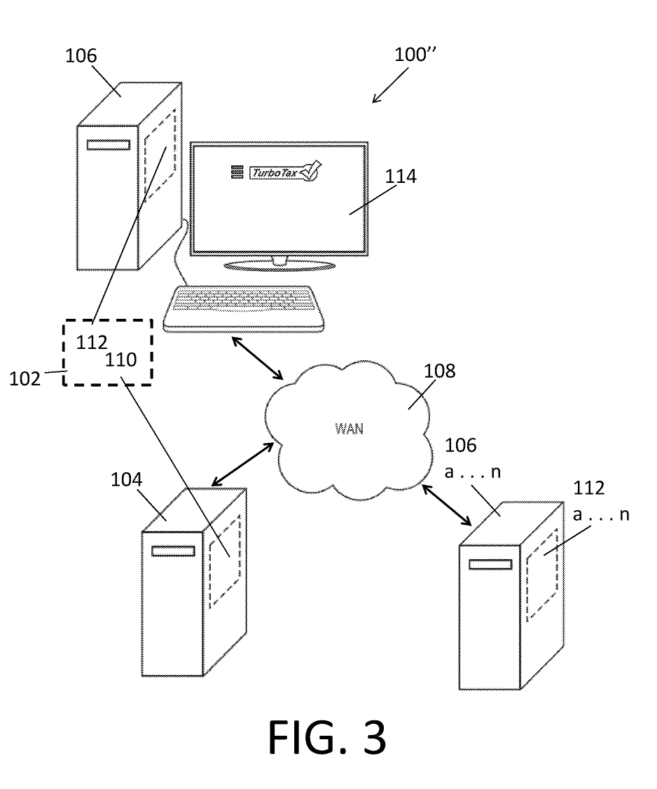

FIG. 3 depicts still another exemplary hardware system 100″ on which an estimated result calculation system 102 according to still another embodiment can be executed. The hardware system 100″ depicted in FIG. 3 is similar to the hardware system 100 depicted in FIG. 1. However, in addition to the server computing device 104 and the tax return preparation computing device 106, the hardware system 100″ also includes a plurality of other tax return preparation computing device 106a . . . 106n operatively coupled to the server computing device 104 and the tax return preparation computing device 106 via the network 108. The plurality of other tax return preparation computing device 106a . . . 106n hosts a respective plurality of other tax return preparation programs 112a . . . 112n, from which the server computing device 104 and the tax return preparation computing device 106 may obtain taxpayer data.

Exemplary taxpayer data that may be obtained from the plurality of other tax return preparation programs 112a . . . 112n include anonymized taxpayer data associated with a plurality of taxpayers. While FIG. 3 depicts the server computing device 104, the tax return preparation computing device 106 and the plurality of other tax return preparation computing device 106a . . . 106n as being operatively coupled by the same network 108, in other embodiments, these computing devices may be operatively coupled by a plurality of networks. While FIG. 3 depicts the predictive model 110 and the plurality of tax return preparation programs 112a . . . 112n as running on separate computing devices 104, 106a . . . 106n, in other embodiments, the predictive model 110 and the plurality of tax return preparation programs 112a . . . 112n may run on the same computing device (e.g., the server computing device 104).

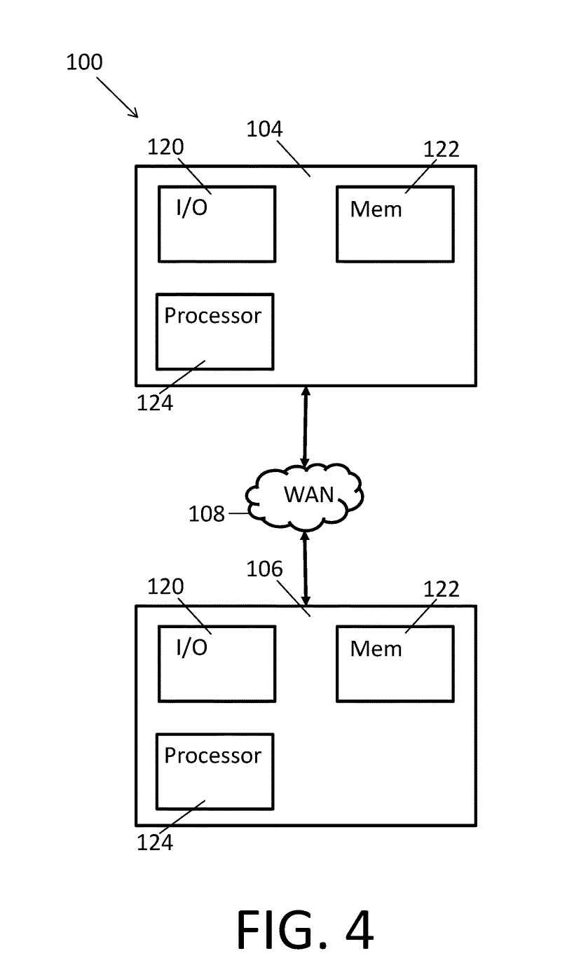

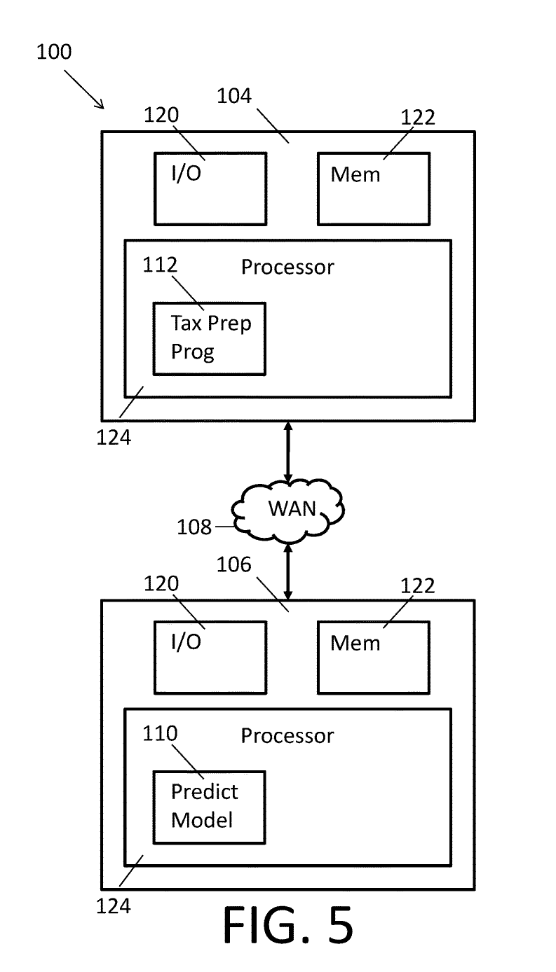

FIG. 4 depicts, in greater detail, another hardware system 100 configured to host an estimated result calculation system 102 according to one embodiment. Like the hardware system 100 depicted in FIG. 1, the hardware system 100 in FIG. 4 includes a server computing device 104 and a tax return preparation computing device 106 that are operatively coupled by a network 108. The server computing device 104 includes an input/output module 120, a memory module 122 and a processor 124. The tax return preparation computing device 106 includes an input/output module 120, a memory module 122 and a processor 124. The input/output modules 120 are configured to communicate with and facilitate the receipt and transfer of taxpayer data, including data relating to the relevance of taxpayer data categories and sequences of taxpayer data categories. The memory modules 122 are configured to store taxpayer data, including data relating to the relevance of taxpayer data categories and sequences of taxpayer data categories, in proper formats for tax data acquisition and estimated result calculation. The processors 124 in the server computing device 104 and the tax return preparation computing device 106 are configured to respectively run programs (i.e., predictive model 110 and electronic tax return preparation program 112), as shown in FIG. 5.

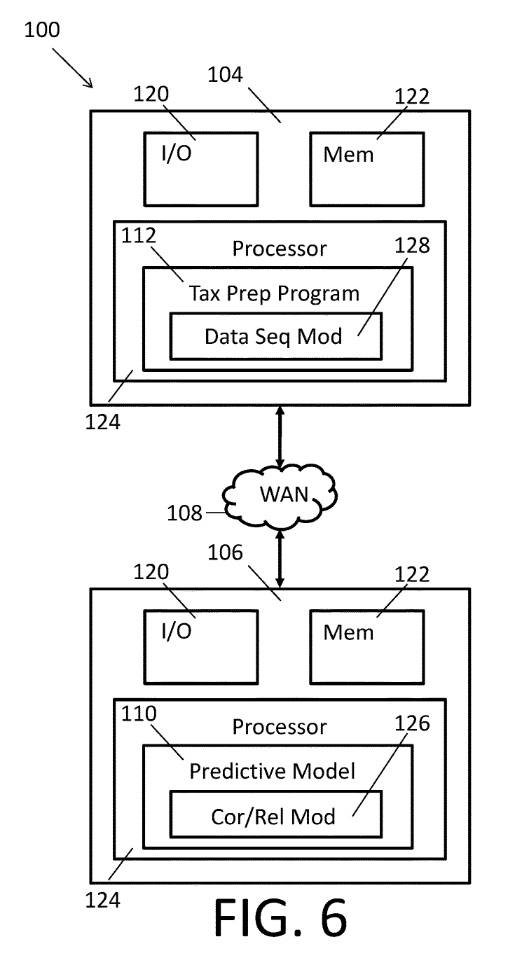

FIG. 6 depicts, in even greater detail, another hardware system 100 configured to host an estimated result calculation system 102 according to one embodiment. Like the hardware system 100 depicted in FIG. 1, the hardware system 100 in FIG. 6 includes a server computing device 104 and a tax return preparation computing device 106 that are operatively coupled by a network 108. The server computing device 104 includes an input/output module 120, a memory module 122 and a processor 124. The tax return preparation computing device 106 includes an input/output module 120, a memory module 122 and a processor 124. The input/output modules 120 are configured to communicate with and facilitate the receipt and transfer of taxpayer data, including data relating to the relevance of taxpayer data categories and sequences of taxpayer data categories. The memory modules 122 are configured to store taxpayer data, including data relating to the relevance of taxpayer data categories and sequences of taxpayer data categories, in proper formats for tax data acquisition and estimated result calculation. The processors 124 in the server computing device 104 and the tax return preparation computing device 106 are configured to respectively run programs (i.e., predictive model 110 and electronic tax return preparation program 112). The predictive model 110 includes a correlation/relevance module 126 configured to determine the correlation and relevance of a taxpayer data category and an estimated result for a particular taxpayer to each other. The tax return preparation program 112 includes a data sequence module 128 configured to generate a sequence in which to obtain taxpayer data. In one embodiment, determining a sequence includes determining an order in which to present questions to obtain taxpayer data.

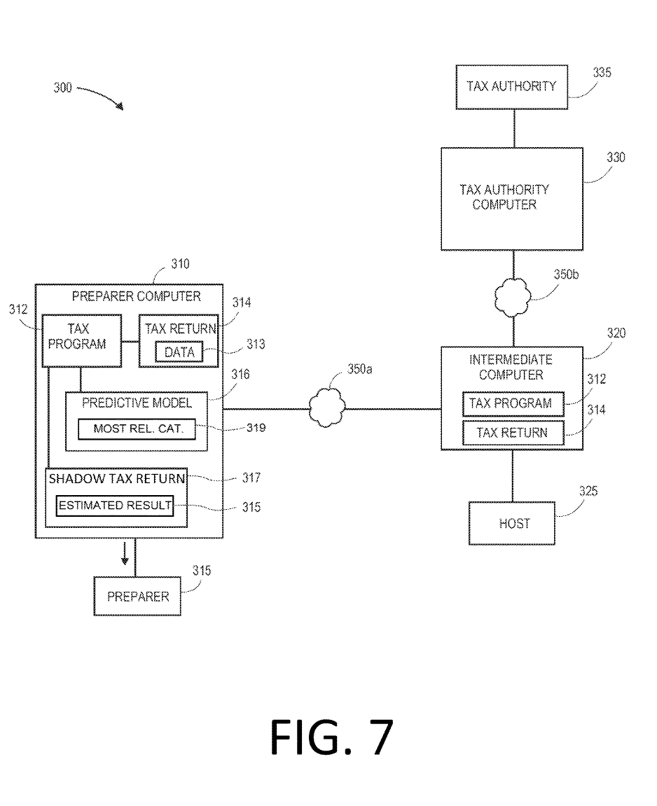

FIG. 7 depicts a system 300 for generating an estimated result 315 for a shadow tax return 317 that is presented to a preparer or user according to another embodiment. The system 300 comprises or involves a preparer computing apparatus or computing device 310 on which a tax return preparation program 312 (identified as “tax program” 312 in FIG. 7) executes to prepare an electronic tax return 314 (identified as “tax return” 314 in FIG. 7) that includes fields for tax return data 313 (data 313 in FIG. 7).

Preparer computing device 310 further comprises or accesses a special purpose predictive model 316, configured to identify a taxpayer data category 319 as most relevant to the estimated result for a particular taxpayer. FIG. 7 illustrates tax return preparation program 312 and predictive model 316 as separate programs, but in other embodiments, predictive model 316 may be a part or module of tax return preparation program 312. Further, while FIG. 7 illustrates tax return preparation program 312, predictive model 316 as running on the same preparer computing device 310, one or more of these system components may run on a remote computing device that is accessible by preparer computing device 310 through a network.

System 300 may also include or involve a special purpose intermediate computing device 320 managed by a host 325. Intermediate computing device 320 is specially or particularly configured or operable to host an on-line version of tax return preparation program 312 and/or format and electronically file electronic tax returns 314 (but not the shadow tax return 317) with a computing device 330 of a tax authority 335. Examples of a tax authority or other tax collecting entity include a federal tax authority, e.g., the Internal Revenue Service (IRS), a state tax authority or other tax collecting entity of the United States, a state thereof, or another country or state thereof (generally, “tax authority”). Examples of hosts 325 that provide the special purpose intermediate computing device 320 include, for example, Intuit Inc., which provides a second or intermediate computing device 320 or server of the Intuit Electronic Filing Center for electronically filing tax returns 312 and other hosts 325 that provide tax return preparation programs 312 and electronic filing servers.

In the illustrated embodiment, tax return preparation program 312 is a local program that executes on preparer computing device 310, but embodiments may also involve on-line tax return preparation programs 312 hosted by intermediate computing device 320 or a separate computing apparatus or server (not shown in FIG. 7) and accessed by a browser running on a preparer computing device 310. For ease of explanation, reference is made generally to tax return preparation program 312 and predictive model 316.

For these and other communication purposes, preparer computing device 310 is operably coupled to or in communication with second or intermediate computing device 320 through a network 350a, and intermediate computing device 320 is operably coupled to or in communication with tax authority computing device 330 through a network 350b. Each of the networks 350a-b and other networks 108 discussed herein (generally, network 108, 350) may be different, or two or more networks 108, 350 may be the same depending on the system configuration and communication protocols employed. One or more or all of networks 108, 350 may be, for example, a wireless or cellular network, a Local Area Network (LAN) and/or a Wide Area Network (WAN). Reference to network 108, 350 generally is not intended to refer to a specific network or communications protocol, and embodiments can be implemented using various networks 108, 350 and combinations thereof.

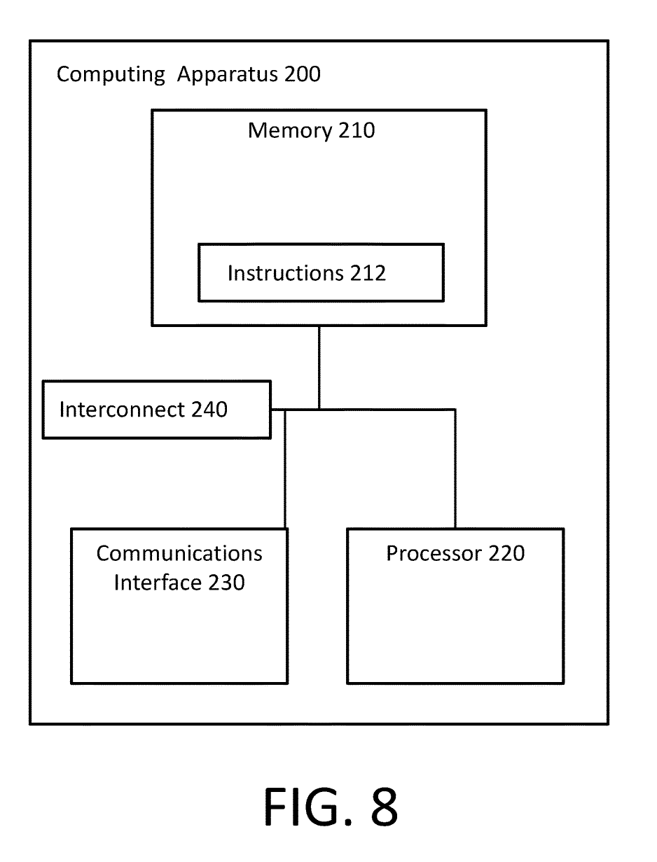

FIG. 8 generally illustrates certain components of a computing device 200 that may be utilized to execute embodiments and that includes a memory 210, program instructions 212, a processor or controller 220 to execute instructions 212, a network or communications interface 230, e.g., for communications with a network or interconnect 240 between such components. The memory 210 may be or include one or more of cache, RAM, ROM, SRAM, DRAM, RDRAM, EEPROM and other types of volatile or non-volatile memory capable of storing data. The processor unit 220 may be or include multiple processors, a single threaded processor, a multi-threaded processor, a multi-core processor, or other type of processor capable of processing data. Depending on the particular system component (e.g., whether the component is a computing device or a hand held mobile communications device), the interconnect 240 may include a system bus, LDT, PCI, ISA, or other types of buses, and the communications or network interface may, for example, be an Ethernet interface, a Frame Relay interface, or other interface. The network interface 230 may be configured to enable a system component to communicate with other system components across a network which may be a wireless or various other networks. It should be noted that one or more components of computing device 200 may be located remotely and accessed via a network. Accordingly, the system configuration provided in FIG. 8 is provided to generally illustrate how embodiments may be configured and implemented. The processors 124 in the server computing device 104 and the tax return preparation computing device 106 are programmed with respective electronic tax return preparation program 112 and predictive model 110 so that they are no longer generic computing devices.

Having described various aspects of estimated result calculation systems according to various embodiments, computer-implemented methods for calculating estimated results during preparation of an electronic tax return using the estimated result calculation systems will now be described. The methods also include identifying a tax data category as most relevant to the estimated result of a particular taxpayer.

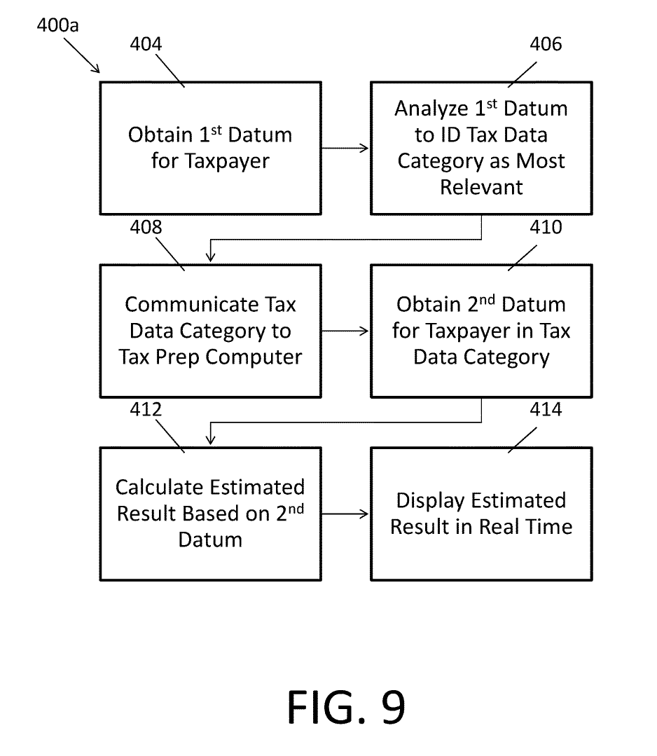

FIG. 9 depicts a computer-implemented method 400a for calculating estimated results during preparation of an electronic tax return according to one embodiment. The method 400a may be implemented using the estimated result calculation systems (e.g., 102) running on the hardware systems (e.g., 100, 300) depicted in FIGS. 1-7.

At step 404, the system 100, 300 obtains a first taxpayer datum associated with a taxpayer. The first taxpayer datum may be obtained by a server computing device 104, which may, in turn, obtain the first taxpayer datum from a tax return preparation computing device 106. Alternatively, the server computing device 104 may obtain the first taxpayer datum from a taxpayer data computer 116 (e.g., as shown in FIG. 2) or directly from a user. Also, the tax return preparation computing device 106, may, in turn, obtain the first taxpayer datum from a taxpayer data computer 116 (e.g., as shown in FIG. 2) or directly from a user. The taxpayer data computer 116 may be a third party computer, as described above. In embodiments where the first taxpayer datum is obtained from a taxpayer data computer 116, the first taxpayer datum may be obtained without user intervention.

At step 406, the system 100, 300 (in particular, the correlation/relevance module 126 of the predictive model 110 running on the server computing device 104) analyzes the first taxpayer datum to identify a taxpayer data category as most relevant to the estimated result for the taxpayer. The predictive model 110 running on the system 100, 300 can analyze the first taxpayer datum to identify a most relevant taxpayer data category according to various embodiments of predictive models 110, as described below.

In one embodiment, the predictive model includes data analytics or “big data” analytics. The predictive model may include calculating a change in an estimated result based on a percentage change in a taxpayer data category value. The predictive model may include determining a correlation between a taxpayer data category and an estimated result in a plurality of tax returns. For example, when determining whether educator expenses (line 23 on Form 1040) is predictive of refund (line 75 on Form 1040), the correlation between those fields on other tax returns (either from previous tax years or the current tax year) can be used as a good predictor.

The predictive model may include calculating a Pearson product-moment correlation coefficient, which is defined as the covariance of two fields (e.g., a taxpayer data category and an estimated result) divided by the standard deviation of each field. For example, if wages (line 7 on Form 1040) and total tax (line 63 on Form 1040) have a Pearson product-moment correlation coefficient of 0.95, then wages (line 7 on Form 1040) is a very good predictor of total tax (line 63 on Form 1040). This technique is particularly effective when a large corpus of other tax returns (e.g., a group of the previous year's tax returns) is available for analysis to calculate the Pearson product-moment correlation coefficient. Further, the Pearson product-moment correlation coefficient can be used a scoring mechanism to determine how well one field predicts the value of another field.

The predictive model may include sensitivity analysis to obtain the correlation between two fields (e.g., a taxpayer data category and an estimated result). Sensitivity analysis generally includes making small changes to one field and observing the impact on another field. For example, for a set of estimated values for wages (line 7 on Form 1040) and tax due (line 63 on Form 1040), the tax due can be recomputed after the wages has been changed by a small percentage. If the resulting change to tax due (line is large, then wages is strongly correlated to (e.g., a good predictor for) tax due. Typical sensitivity analysis requires estimates for one or more taxpayer data category values (e.g., to understand the sensitivity of tax due on wages typically requires an estimate for wages). These taxpayer data category values can be estimated as described in U.S. patent application attorney docket no. INT-263-US1 (158622), the contents of which have been previously incorporated-by-reference herein.

The predictive model may include analyzing a tax code. For example, line 4 on Schedule A is calculated from line 1 on Schedule A and line 38 on Form 1040 via a well-defined formula. Therefore, that formula determines the correlation between line 4 on Schedule A, and line 1 on Schedule A and line 38 on Form 1040.

The predictive model may include determining a relationship between two fields by analyzing their respective relationships to a third field. For example, if wages (line 7 on Form 1040) are a good predictor of adjusted gross income (line 38 on Form 1040), and adjusted gross income is a good predictor of total tax (line 63 on Form 1040), then it follows that wages is at least a reasonable predictor of total tax. This cascading of predictive values can also be used to calculate correlation coefficients for a plurality of fields. For example, if wages predicts adjusted gross income with 90% accuracy and adjusted gross income predicts total tax with 80% accuracy, then it can be calculated that wages predict total tax with 72% (=90%×80%) accuracy. This calculation for determining the correlation coefficients for cascaded predictors is only exemplary. The actual calculation will depend on the particular scoring mechanism.

The predictive model may include removing data/information with low predictive value. While other predictive models involve calculating the predictive value of a particular taxpayer data category independent of other taxpayer data categories, this predictive model begins with an estimate of all category (or the major categories) that typically impact a target field (e.g., estimated result). These taxpayer data category values can be estimated as described in U.S. patent application attorney docket no. INT-263-US1 (158622), the contents of which have been previously incorporated-by-reference herein. Each estimated category is then analyzed to identify its predictive value for (correlation/relevance to) the target field as described above. Then, the category with the lowest predictive value is removed from the analysis, and the method is repeated until a single last taxpayer data category remains. This single last taxpayer data category is then identified as the most relevant taxpayer data category.

In one embodiment, the predictive model may include requesting the user to identify the taxpayer data category as the most relevant to the estimated result for the taxpayer.

Returning to the method 400a depicted in FIG. 9, at step 408, the system 100, 300 (e.g., the server computing device 104) communicates the taxpayer data category identified as most relevant to the estimated result for the taxpayer to the tax return preparation computing device 106. In one embodiment, server computing device 104 communicates the identity of the taxpayer data category. In those embodiments, the data sequence module 128 in the tax return preparation computing device 106 may generate a sequence of taxpayer data categories for use in data acquisition during tax return preparation. In another embodiment, the server computing device 104 (perhaps a data sequence module therein) determines and communicates a sequence of taxpayer data categories with the taxpayer data category at a beginning of the sequence.

At step 410, the system 100, 300 (e.g., the tax return preparation computing device 106) obtains a second taxpayer datum associated with the most relevant taxpayer data category. The tax return preparation computing device 106, may obtain the second taxpayer datum from a taxpayer data computer 116 (e.g., as shown in FIG. 2) or directly from the user. The taxpayer data computer 116 may be a third party computer, as described above. In embodiments where the first taxpayer datum is obtained from a taxpayer data computer 116, the second taxpayer datum may be obtained without user intervention.

The tax return preparation computing device 106 may explicitly ask the user for data/information that is believed to have the highest predictive value for the target field (e.g., total tax (line 63 on Form 1040) or refund (line 75 on Form 1040)). For example, the user may start by indicating that they are most interested in an estimate of the refund. The system 100, 300 determines (e.g., using one or more of the predictive models 110 described above) that wages (line 7 on Form 1040) is most predictive of the refund. The tax return preparation computing device 106 may ask the user to manually enter the wages data/information. Alternatively or additionally, the tax return preparation computing device 106 may obtain the user's wages data/information automatically from a payroll provider (W-2 data). Next, the system 100, 300 determines that home mortgage interest paid is now the most predictive of the refund. Therefore, the tax return preparation computing device 106 next obtains the user's home mortgage interest paid either manually from the user or automatically from the payroll provider.

In another embodiment, the system (100, 300) uses the identified most relevant taxpayer data category to generate a recommendation to the user rather than driving the user interaction. For example, the tax return preparation computing device 106 may present a list of hyperlinked taxpayer data categories/fields with high predictive values (with explanation) in a sidebar, thereby enabling the user to jump to those parts of the interview. Alternatively, the list of taxpayer data categories/fields with high predictive values may be available in a drop-down menu.

At step 412, the system 100, 300 (e.g., the tax return preparation computing device 106) calculates an estimated result based at least on the second taxpayer datum. The other yet-to-be-obtained taxpayer data category values can be estimated for this calculation as described in U.S. patent application attorney docket no. INT-263-US1 (158622), the contents of which have been previously incorporated-by-reference herein.

Finally, at step 414, the system 100, 300 (e.g., the tax return preparation computing device 106) displays the estimated result to the user during preparation of the electronic tax return. The tax return preparation computing device 106 may display the estimated result after entry of each item of taxpayer data, or after each page of a taxpayer data entry user interface. The tax return preparation computing device 106 may display the estimated result in a consistent location (e.g., in the top right margin) of a visual display/screen 114 of the tax return preparation computing device 106.

This method 400 results in earlier calculation of a more accurate estimated result, thereby increasing and maintaining the user's engagement in the electronic tax return preparation process 400 and confidence in the electronic tax return preparation system 100, 300. Any reference to specific fields in a tax form is based on the 2014 form set, but this method is applicable to any tax return preparation system.

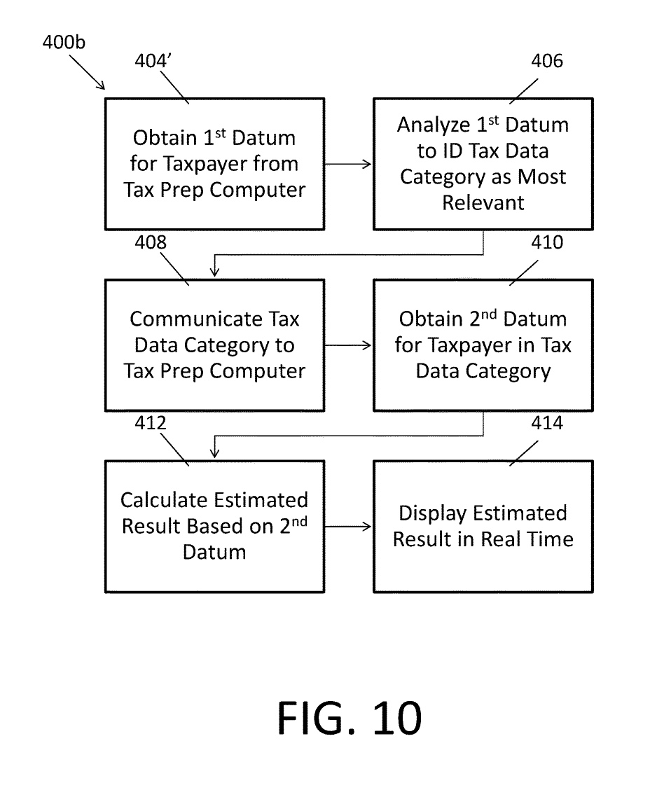

FIG. 10 depicts a computer-implemented method 400b for calculating estimated results during preparation of an electronic tax return according to another embodiment. The method 400b may be implemented using the estimated result calculation systems (e.g., 102) running on the hardware systems (e.g., 100, 300) depicted in FIGS. 1-7.

The method 400b depicted in FIG. 10 is almost identical to the method 400a depicted in FIG. 9. The difference is that, in step 404′, the server computing device 104 obtains the first taxpayer datum for the taxpayer from the tax return preparation computing device 106 through the network 108. The remaining steps depicted in FIG. 10 are identical to the corresponding steps depicted in FIG. 9 and described above.

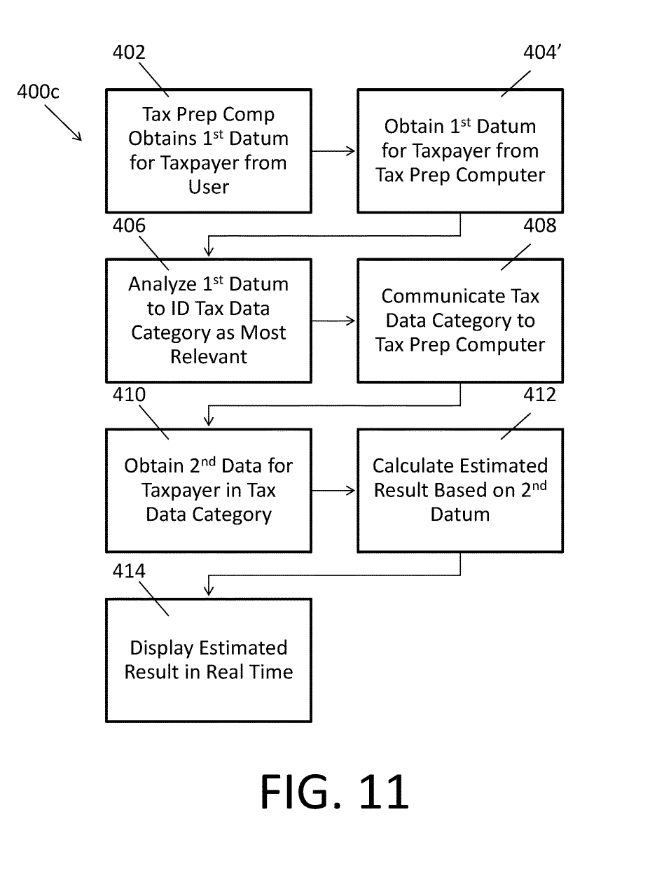

FIG. 11 depicts a computer-implemented method 400c for calculating estimated results during preparation of an electronic tax return according to still another embodiment. The method 400c may be implemented using the estimated result calculation systems (e.g., 102) running on the hardware systems (e.g., 100, 300) depicted in FIGS. 1-7.

The method 400c depicted in FIG. 11 is almost identical to the method 400b depicted in FIG. 10. The difference is the addition of step 402 before step 404′. In step 402, the tax return preparation computing device 106 obtains the first taxpayer datum for the taxpayer from the user as described above. The remaining steps depicted in FIG. 11 are identical to the corresponding steps depicted in FIG. 10 and described above.

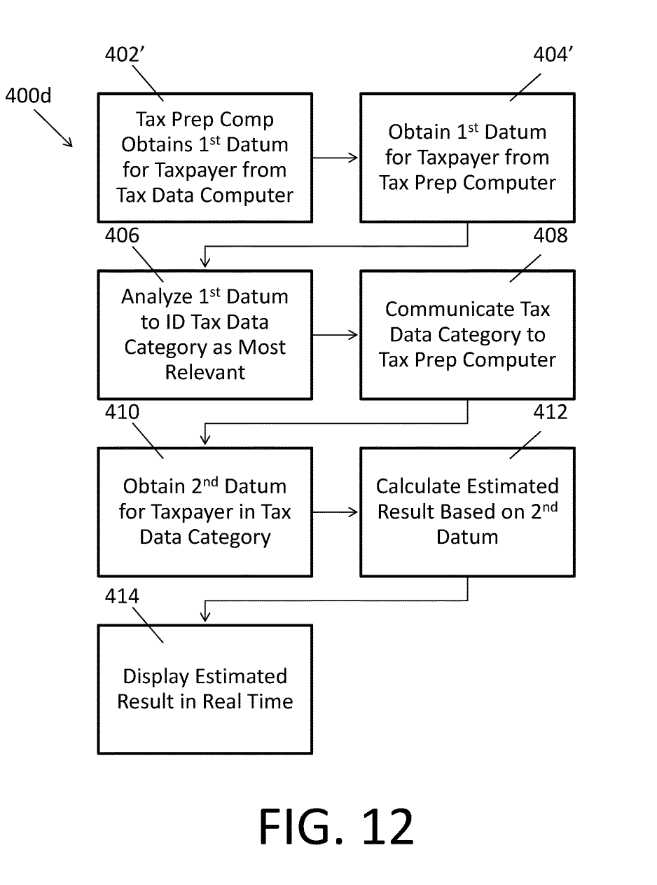

FIG. 12 depicts a computer-implemented method 400d for calculating estimated results during preparation of an electronic tax return according to yet another embodiment. The method 400d may be implemented using the estimated result calculation systems (e.g., 102) running on the hardware systems (e.g., 100, 300) depicted in FIGS. 1-7.

The method 400d depicted in FIG. 12 is almost identical to the method 400b depicted in FIG. 10. The difference is the addition of step 402′ before step 404′. In step 402′, the tax return preparation computing device 106 obtains the first taxpayer datum for the taxpayer from a taxpayer data computing device 116 through the network 108 as described above. The remaining steps depicted in FIG. 12 are identical to the corresponding steps depicted in FIG. 10 and described above.

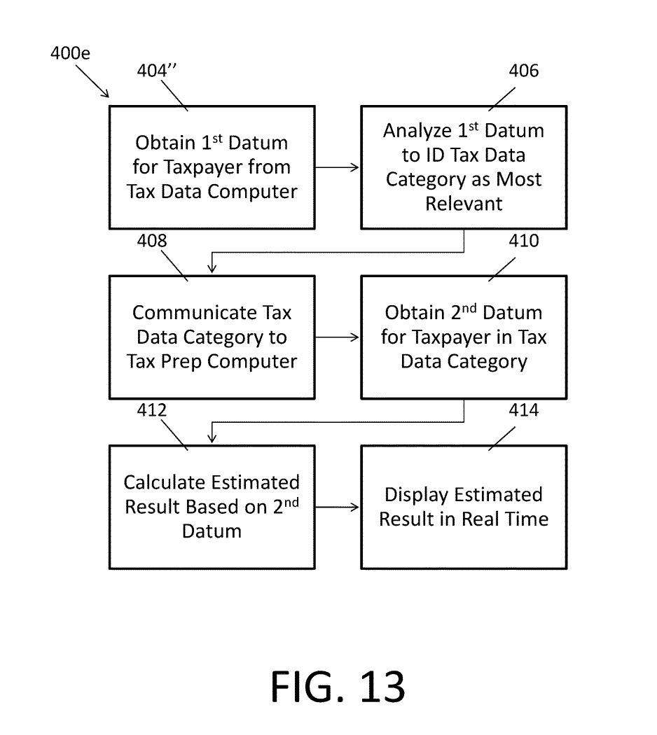

FIG. 13 depicts a computer-implemented method 400e for calculating estimated results during preparation of an electronic tax return according to another embodiment. The method 400e may be implemented using the estimated result calculation systems (e.g., 102) running on the hardware systems (e.g., 100, 300) depicted in FIGS. 1-7.

The method 400e depicted in FIG. 13 is almost identical to the method 400a depicted in FIG. 9. The difference is that, in step 404″, the server computing device 104 obtains the first taxpayer datum for the taxpayer from a taxpayer data computing device 116 through the network 108 as described above. The remaining steps depicted in FIG. 13 are identical to the corresponding steps depicted in FIG. 9 and described above.

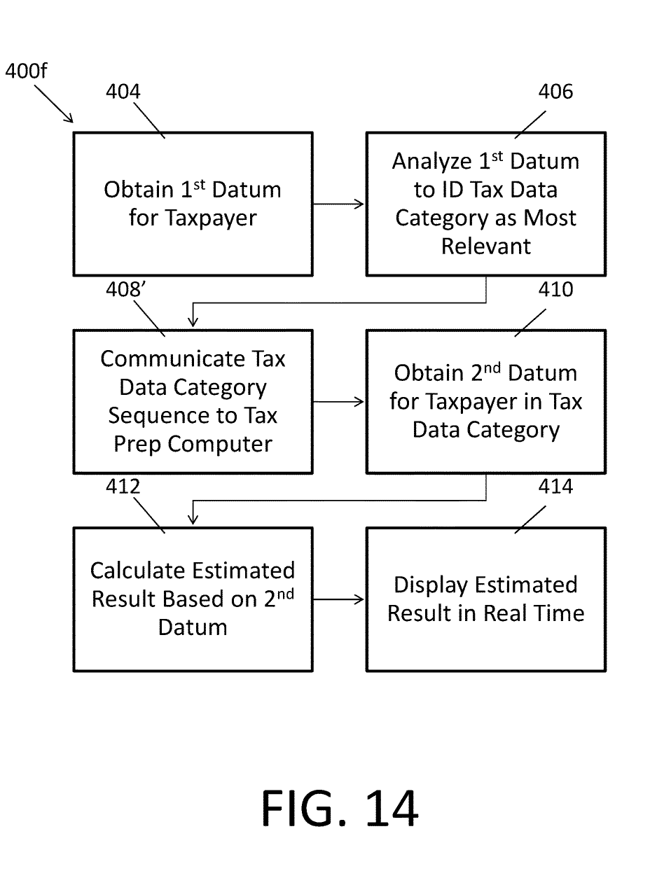

FIG. 14 depicts a computer-implemented method 400f for calculating estimated results during preparation of an electronic tax return according to still another embodiment. The method 400f may be implemented using the estimated result calculation systems (e.g., 102) running on the hardware systems (e.g., 100, 300) depicted in FIGS. 1-7.

The method 400f depicted in FIG. 14 is almost identical to the method 400a depicted in FIG. 9. The difference is that, in step 408′, the server computing device 104 communicates a tax data category sequence (with the most relevant taxpayer data category at the beginning of the sequence) to the tax return preparation computing device 106 through the network 108 as described above. The remaining steps depicted in FIG. 14 are identical to the corresponding steps depicted in FIG. 9 and described above.

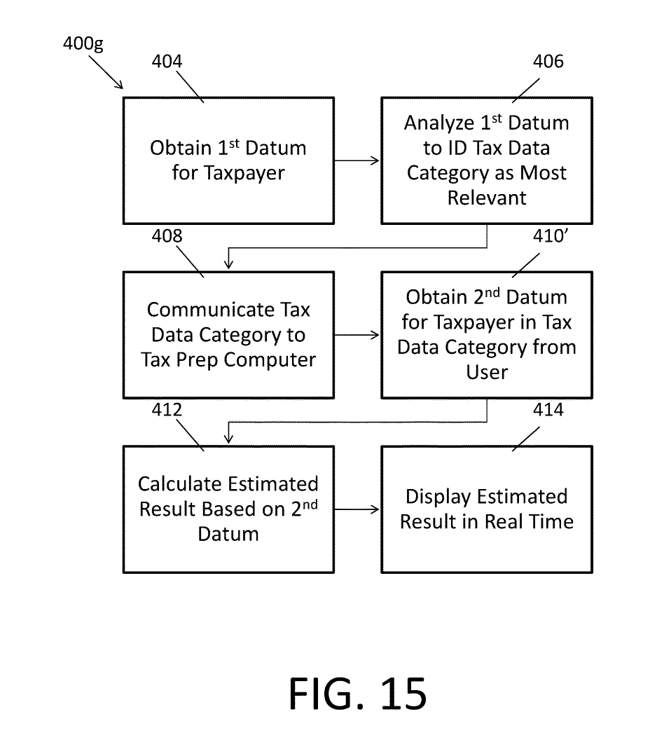

FIG. 15 depicts a computer-implemented method 400g for calculating estimated results during preparation of an electronic tax return according to another embodiment. The method 400g may be implemented using the estimated result calculation systems (e.g., 102) running on the hardware systems (e.g., 100, 300) depicted in FIGS. 1-7.

The method 400g depicted in FIG. 15 is almost identical to the method 400a depicted in FIG. 9. The difference is that, in step 410″, the server computing device 104 obtains the second taxpayer datum for the taxpayer from the user as described above. The remaining steps depicted in FIG. 15 are identical to the corresponding steps depicted in FIG. 9 and described above.

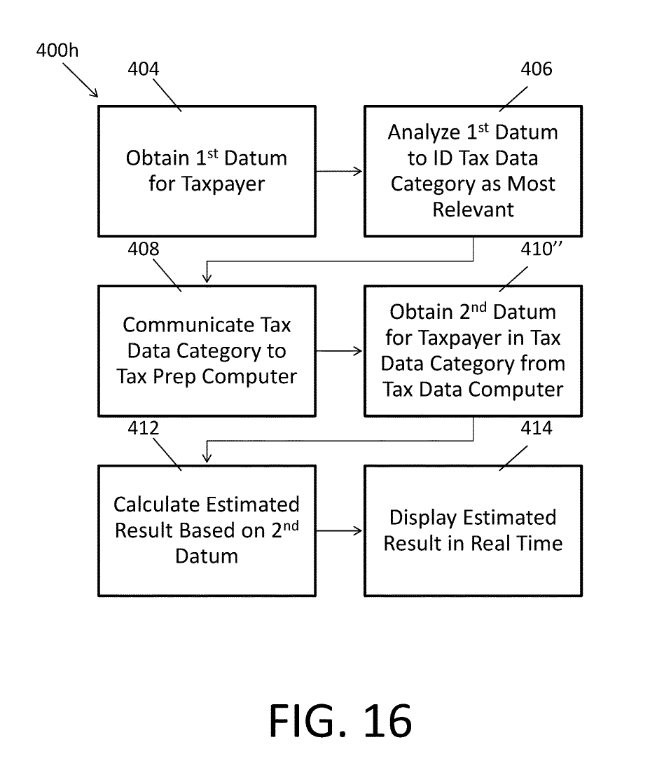

FIG. 16 depicts a computer-implemented method 400h for calculating estimated results during preparation of an electronic tax return according to another embodiment. The method 400h may be implemented using the estimated result calculation systems (e.g., 102) running on the hardware systems (e.g., 100, 300) depicted in FIGS. 1-7.

The method 400h depicted in FIG. 16 is almost identical to the method 400a depicted in FIG. 9. The difference is that, in step 410″, the server computing device 104 obtains the second taxpayer datum for the taxpayer from a taxpayer data computing device 116 through the network 108 as described above. The remaining steps depicted in FIG. 16 are identical to the corresponding steps depicted in FIG. 9 and described above.

While FIGS. 9-16 illustrate embodiments of using a single second taxpayer datum to calculate an estimated result, embodiments are not so limited. For example, the system 100, 300 may identify a plurality of high relevance taxpayer data categories and obtain taxpayer data corresponding to those high relevance taxpayer data categories to calculate an even more accurate estimated result.

While FIGS. 9-16 illustrate a single predictive model 110 being used in each method 400a-h, embodiments are not so limited. For example, multiple predictive models can be applied to each set of taxpayer data categories to arrive at a consensus most relevant taxpayer data category. Also, different predictive models or pluralities of predictive models can be applied to a time series of taxpayer data categories during tax return preparation. Accordingly, it will be understood that embodiments described are provided for purposes of illustration and explanation, not limitation, and embodiments may involve repeating execution of the same predictive model, selection of a different predictive model, or a combination of both embodiments.

In another embodiment, a method for calculating an estimated result during preparation of an electronic tax return includes an estimated result calculation system 102 collecting tax data from existing tax filers. For instance, by April 1^{st} of a tax year, the system 102 can have collected tax data from returns filed between January 1^{st} and March 31^{st}.

Next, the system 102 analyzes the collected tax data to identify high relevance taxpayer data categories/fields that the user has not yet entered based on information the user has already entered. For example, based on the user's zip code, wages, and property taxes paid from the previous year, the system 102 may determine that the user's property tax paid for this year is most relevant to the user's tax due. A wide range of techniques can be used for this analysis as described above.

When a new tax filer begins to prepare their tax return, the user will have provided some taxpayer information or tax information about their tax situation. Using this information and the predictive models described above, the system 102 obtains the most relevant tax datum. The system 102 then calculates an estimated result (e.g., tax due) based on the obtained most relevant tax datum and predicted tax data for the fields the user has not yet entered. Finally, the system 102 displays the estimated result to the user.

Optionally, based on the estimated result (for example, if the predicted tax due value changes significantly when the user enters a new piece of information), the system 102 may take action (e.g., present messaging) to appropriately engage the user. This action may include explanation (for a change in the expected tax outcome), confirmation (that the user has entered the correct amount when it varies from what was expected), congratulations (for increasing earnings or deductions), consolation (for not having paid sufficient estimated taxes), or other engagement to improve the user experience. Further, the system 102 may present the messaging before the user enters the new piece of information if the system 102 determines that the new piece of information is in a very relevant taxpayer data category (e.g., “Your mortgage interest paid will have a large effect on your tax due. Let's get this information to improve the estimate of your tax due.”)

The system 102 can utilize data from various external sources to execute the method. In one embodiment, the data collected for analysis includes tax returns from other filers for the current year. In another embodiment, the data collected for analysis includes tax returns from other filers for previous years. In still another embodiment, the data collected for analysis includes tax information from external sources (such as the IRS or state tax agencies).

The system 102 can utilize various taxpayer data to execute the method. In one embodiment, data used to identify relevant taxpayer data categories for the current taxpayer includes information they have already entered on their current tax return. In another embodiment, data used to identify relevant taxpayer data categories for the current taxpayer includes information from their previous tax returns. In still another embodiment, data used to identify relevant taxpayer data categories for the current taxpayer includes information from external sources (such as county property tax records).

In one embodiment, the user may enter selected questions about the predicted final tax outcome. For example, “What assumptions were used in calculating the predicted final tax outcome?” or “Why did it change so much when I entered that last field?”. In another embodiment, the system 102 may take initiative to interact with the user based on the amount of the predicted tax outcome or based on changes in the amount of the predicted tax outcome. In still another embodiment, the initiative taken by the system may include actions designed to improve the user experience. For example, taking a sympathetic tone, offering advice on how to get a better result, explain why the expected tax outcome is what it is, etc. In yet another embodiment, the initiative taken by the system may include simple social interaction. For example, encouragement, congratulations, consolation, etc.

In one embodiment, the taxpayer has entered their W-2 information and is most interested in their estimated refund. Following a pre-determined sequence for taxpayer data acquisition, the system 102 may generate an estimated refund that varies significantly with each taxpayer datum entered. Based analysis of tax data (e.g., the entered W-2 data and data from other tax filers with similar characteristics), the system 102 determines that mortgage interest paid is the most relevant taxpayer data category for the taxpayer. The system 102 acquires the taxpayer's mortgage interest paid (from the user or from the county tax collector) together with a message that mortgage interest paid will allow the system to calculate a more accurate estimated refund. The taxpayer observes that the system 102 is personalized to their characteristics, and the taxpayer is more engaged and confident. The system 102 calculates an estimated refund that is in the range of the taxpayer's expectations, improving engagement and confidence.

Next, the system 102 determines that property tax paid is the next most relevant taxpayer data category, acquires that taxpayer datum, and calculates another estimated refund. The taxpayer observes that the estimated refund has changed by a relatively minor amount and is even more engaged and confident. This process continues until the return is complete.

Method embodiments or certain steps thereof, some of which may be loaded on certain system components, computers or servers, and others of which may be loaded and executed on other system components, computers or servers, may also be embodied in, or readable from, a non-transitory, tangible medium or computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, DVD-RW, or other carrier now known or later developed capable of storing data. The processor 220 performs steps or executes program instructions 212 within memory 210 and/or embodied on the carrier to implement method embodiments.

Although particular embodiments have been shown and described, it should be understood that the above discussion is not intended to limit the scope of these embodiments. While embodiments and variations of the many aspects of embodiments have been disclosed and described herein, such disclosure is provided for purposes of explanation and illustration only. Thus, various changes and modifications may be made without departing from the scope of the claims.

For example, while certain embodiments have been described with reference to simplified predictive model examples, predictive models can be substantially more complex such that predictive models, and combinations thereof, can be utilized across different types of taxpayer data and taxpayer data categories. For example, a simple example of a predictive model may involve more complex relationships, e.g., clustering tax returns based on zip code, wages, age using K-means, identifying which cluster a user belongs to, then using the mean for that cluster for the predicted tax datum, and with further complexity. These predictive model capabilities are not available in known tax return preparation applications.

Moreover, while embodiments have been described with reference to data that has been entered into a field, e.g., by the user, predictive models may also be utilized to analyze data that is calculated or derived from other data.

While certain embodiments involving predictive models to identify a most relevant taxpayer data category and calculate an estimated result of a shadow tax return, embodiments may also be used together or concurrently.

Further, while the specification refers to certain predictive models that may be executed for use in embodiments, predictive models that can be utilized in embodiments can be created in various ways including, for example, using extrema values (min and max) on related tax returns, error ranges (range of uncertainty) for curves fitted to data in tax returns, clusters of similar users using naïve bayes, K-means clustering or other clustering techniques, a k-nearest neighbor algorithm, neural networks and logistic regression, and combinations of two or more of the aforementioned or other types of predictive models.

Moreover, the system 102 can execute predictive models at various times during the methods. As the system obtains more information about the user (either because the user has entered the information or because the system has obtained the information from another source on behalf of the user), that information is added to the collection of known facts about the user, and this may be used to re-evaluate or re-execute the predictive model such that a new most relevant taxpayer data category and a new estimated result is generated after the data was entered, and in response to new tax data that was entered and resulted in execution of a predictive model again or another predictive model. For example, a predictive model can be evaluated whenever new information is available about the user. The results of the evaluation of the predictive model may be accessed whenever it is required, which may result in the latest available results of the predictive model not being based on all available information about the user depending on when the predictive model is accessed and executed.

A predictive model can be evaluated (to completion) before the user is allowed to take any further action, thus providing immediate feedback to the user.

External data may be used to start the predictive model prediction process, or be utilized throughout the prediction process. For example, after a field is populated with first tax data, embodiments may involve executing a predictive model with the first tax data as an input, and then generating an output that is calculate an estimated result. In another embodiment, after a field is populated with first tax data, embodiments may involve executing a predictive model with the first tax data as an input and, in additional, one or more external data if available, and then generating an output that is used to calculate an estimated result in a shadow tax return. External data may be used as inputs into one or multiple predictive models that are executed simultaneously or in iterations as additional tax data is received.

According to one embodiment, external data is utilized as an input if or when it is available. According to another embodiment, external data is used to launch the predictive model, e.g., when there is sufficient data in the electronic tax return fields such that a pre-determined minimum number of fields, or pre-determined types or specific fields have been populated, then external data is no longer utilized and instead, only data of the electronic tax return is utilized as inputs to a predictive model.

Further, while certain embodiments have been described with reference to identifying a most relevant taxpayer data category and calculating estimated tax results by execution of one or more predictive models, embodiments may utilized one of these embodiments or both of these embodiments at different times or simultaneously. For example, when a user requests an updated estimated result, the system can execute one or more predictive models.

Where methods and steps described above indicate certain events occurring in certain order, those of ordinary skill in the art having the benefit of this disclosure would recognize that the ordering of certain steps may be modified and that such modifications are in accordance with the variations of the disclosed embodiments. Additionally, certain of the steps may be performed concurrently in a parallel process as well as performed sequentially. Thus, the methods shown in various flow diagrams are not intended to be limited to a particular sequential order, unless otherwise stated or required.

Accordingly, embodiments are intended to exemplify alternatives, modifications, and equivalents that may fall within the scope of the claims.

What is claimed is:

1. A system for calculating an estimated result during preparation of an electronic tax return, the system comprising:
a server computer having a predictive model running thereon; and
a tax return preparation computer operatively coupled to the server computer by a network and having an electronic tax return preparation program running thereon,
wherein the server computer is configured to obtain a first taxpayer datum associated with a taxpayer and execute the predictive model,
wherein the predictive model, when executed, analyzes the first taxpayer datum to identify a taxpayer data category as most relevant to the estimated result for the taxpayer,
wherein the server computer is configured to communicate the taxpayer data category identified as most relevant to the tax return preparation computer,
wherein the tax return preparation computer is configured to obtain a second taxpayer datum associated with the taxpayer and corresponding to the taxpayer data category identified as most relevant,
wherein the tax return preparation computer is configured to calculate the estimated result for the taxpayer based, at least in part, on the second taxpayer datum, and
wherein the tax return preparation computer is configured to display the estimated result to a user during preparation of the electronic tax return.

2. The system of claim 1, wherein the predictive model is an algorithm that was created using a modeling technique selected from the group consisting of Pearson product-moment correction; sensitivity analysis; logistic regression; naive bayes; k-means classification; K-means clustering; other clustering techniques; k-nearest neighbor; neural networks; decision trees; random forests; boosted trees; k-nn classification; kd trees; generalized linear models; support vector machines; and substantial equivalents thereof.

3. The system of claim 1, wherein the server computer is configured to obtain the first taxpayer datum from the tax return preparation computer.

4. The system of claim 3, wherein the tax return preparation computer is configured to obtain the first taxpayer datum from the user.

5. The system of claim 3, wherein the tax return preparation computer is configured to obtain the first taxpayer datum from a taxpayer data computer.

6. The system of claim 5, wherein the taxpayer data computer is a third party computer.

7. The system of claim 1, wherein the server computer is configured to obtain the first taxpayer datum from a taxpayer data computer.

8. The system of claim 7, wherein the taxpayer data computer is a third party computer.

9. The system of claim 1, wherein communicating the taxpayer data category identified as the most relevant to the estimated result for the taxpayer comprises communicating a sequence of taxpayer data categories with the taxpayer data category at a beginning of the sequence.

10. The system of claim 1, wherein the tax return preparation computer is configured to obtain the second taxpayer datum from the user.

11. The system of claim 1, wherein the tax return preparation computer is configured to obtain the second taxpayer datum from a taxpayer data computer.

12. The system of claim 11, wherein the taxpayer data computer is a third party computer.

13. The system of claim 1, wherein the predictive model includes data analytics.

14. The system of claim 1, wherein executing the predictive model includes calculating a Pearson product-moment correlation coefficient.

15. The system of claim 1, wherein executing the predictive model includes calculating a change in the estimated result based on a change to the taxpayer data category.

16. The system of claim 1, wherein executing the predictive model includes determining a correlation between the taxpayer data category and the estimated result in a plurality of tax returns.

17. The system of claim 1, wherein executing the predictive model includes analyzing a tax code.

18. The system of claim 1, wherein executing the predictive model includes:
determining a first correlation between the taxpayer data category and a second taxpayer data category;
determining a second correlation between the estimated result and the second taxpayer data category; and
determining a third correlation between the taxpayer data category and the estimated result based on the first and second correlations.

19. The system of claim 18, wherein executing the predictive model includes:
calculating a first correlation coefficient between the taxpayer data category and the second taxpayer data category;
calculating a second correlation coefficient between the estimated result and the second taxpayer data category; and
calculating a third correlation coefficient between the taxpayer data category and the estimated result based on the first and second correlation coefficients.

20. The system of claim 1, wherein executing the predictive model includes:
a. calculating a plurality of correlation coefficients for a respective first plurality of taxpayer data categories and the estimated result;
b. eliminating one of the first plurality of taxpayer data categories having a lowest correlation coefficient of the plurality of correlation coefficients from the first plurality of taxpayer data categories to form a second plurality of taxpayer data categories;
c. repeating steps a and b with respective pluralities of taxpayer data categories until a single last taxpayer data category remains; and
d. identifying the single last taxpayer data category as the most relevant to the estimated result for the taxpayer.

21. The system of claim 1, wherein executing the predictive model includes requesting the user to identify the taxpayer data category as the most relevant to the estimated result for the taxpayer.

22. A computer-implemented method for calculating an estimated result during preparation of an electronic tax return, the method comprising:
obtaining a first taxpayer datum associated with a taxpayer;
executing a predictive model;
analyzing the first taxpayer datum to identify a taxpayer data category as most relevant to the estimated result for the taxpayer;
obtaining a second taxpayer datum associated with the taxpayer and corresponding to the taxpayer data category identified as most relevant;
calculating the estimated result for the taxpayer based, at least in part, on the second taxpayer datum; and
displaying the estimated result to a user during preparation of the electronic tax return.

23. The method of claim 22, wherein the predictive model is an algorithm that was created using a modeling technique selected from the group consisting of Pearson product-moment correction; sensitivity analysis; logistic regression; naive bayes; k-means classification; K-means clustering; other clustering techniques; k-nearest neighbor; neural networks; decision trees; random forests; boosted trees; k-nn classification; kd trees; generalized linear models; support vector machines; and substantial equivalents thereof.

24. The method of claim 22, wherein the first taxpayer datum is obtained from the user.

25. The method of claim 22, wherein the first taxpayer datum is obtained from a taxpayer data computer.

26. The method of claim 25, wherein the taxpayer data computer is a third party computer.

27. The method of claim 22, further comprising generating a sequence of taxpayer data categories with the taxpayer data category at a beginning of the sequence.

28. The method of claim 22, wherein the second taxpayer datum is obtained from the user.

29. The method of claim 22, wherein the second taxpayer datum is obtained from a taxpayer data computer.

30. The method of claim 29, wherein the taxpayer data computer is a third party computer.

31. The method of claim 22, wherein the predictive model includes data analytics.

32. The method of claim 22, wherein executing the predictive model includes calculating a Pearson product-moment correlation coefficient.

33. The method of claim 22, wherein executing the predictive model includes calculating a change in the estimated result based on a change to the taxpayer data category.

34. The method of claim 22, wherein executing the predictive model includes determining a correlation between the taxpayer data category and the estimated result in a plurality of tax returns.

35. The method of claim 22, wherein executing the predictive model includes analyzing a tax code.

36. The method of claim 22, wherein executing the predictive model includes:
determining a first correlation between the taxpayer data category and a second taxpayer data category;
determining a second correlation between the estimated result and the second taxpayer data category; and
determining a third correlation between the taxpayer data category and the estimated result from the first and second correlations.

37. The method of claim 36, wherein executing the predictive model includes:
calculating a first correlation coefficient between the taxpayer data category and the second taxpayer data category;
calculating a second correlation coefficient between the estimated result and the second taxpayer data category; and
calculating a third correlation coefficient between the taxpayer data category and the estimated result based on the first and second correlation coefficients.

38. The method of claim 22, wherein executing the predictive model includes:
a. calculating a plurality of correlation coefficients for a respective first plurality of taxpayer data categories and the estimated result;
b. eliminating one of the first plurality of taxpayer data categories having a lowest correlation coefficient of the plurality of correlation coefficients from the first plurality of taxpayer data categories to form a second plurality of taxpayer data categories;
c. repeating steps a and b with respective pluralities of taxpayer data categories until a single last taxpayer data category remains; and
d. identifying the single last taxpayer data category as the most relevant to the estimated result for the taxpayer.

39. The method of claim 22, wherein executing the predictive model includes requesting the user to identify the taxpayer data category as the most relevant to the estimated result for the taxpayer.

40. A computer program product comprising a non-transitory computer readable storage medium embodying one or more instructions executable by a computer system having a server computer and a tax return preparation computer to perform a process for calculating an estimated result during preparation of an electronic tax return, the process comprising obtaining a first taxpayer datum associated with a taxpayer, executing a predictive model, analyzing the first taxpayer datum to identify a taxpayer data category as most relevant to the estimated result for the taxpayer, obtaining a second taxpayer datum associated with the taxpayer and corresponding to the taxpayer data category identified as most relevant, calculating the estimated result for the taxpayer based, at least in part, on the second taxpayer datum, and displaying the estimated result to a user during preparation of the electronic tax return.
